(19) United States
(12) Patent Application Publication
(10) Pub. No.: US 2005/0128582 A1
(43) Pub. Date: Jun. 16, 2005

(54) Display screen and its method of production

(76) Inventor: Daniel Gibilini, St. Martin D'Uriage (FR)

Correspondence Address: ROTHWELL, FIGG, ERNST & MANBECK, P.C., 1425 K STREET, N.W., SUITE 800, WASHINGTON, DC, 20005, US

(21) Appl. No.: 10/505,135

(22) PCT Filed: Feb. 18, 2003
(86) PCT No.: PCT/EP03/01684

(30) Foreign Application Priority Data
Feb. 18, 2002 (FR) 0202086
Aug. 30, 2002 (FR) 0210829
Oct. 18, 2002 (FR) 0212987

(51) Int. Cl. G03B 21/60

(52) U.S. Cl. 359/455

(57) ABSTRACT

A screen comprises a support (1) with focusing elements; an active diffuser (3) is fixed to the support; it has an active face directed away from the support and located in the focal plane of the focusing elements of the support; the screen has an opaque layer (2) with a thickness less than 20 μm having openings adapted to let through the light focused by the focusing elements. This opaque layer is formed on the active face of the diffuser, or on an intermediate layer formed on the active layer of said diffuser. The openings in the opaque layer ensure the screen has a high contrast.

The aim of the invention is a display screen for professional and general public applications (television, multi-screen projections, graphic high resolution monitor, etc.).

This type of display screen is described in WO-A-00 67071. The reader may refer to this application for a discussion of the ideal properties of display screens and for definitions of the contrast, the transmittivity and other parameters defining display screens. This type of screen may be used with a projector, possibly with a Fresnel lens for collimating light before it enters the screen.

M. Hasegawa and others, 11.3: Reflective Stacked Crossed Guest-Host Display with a Planarized Inner Diffuser, SID 00 Digest, pages 128-129, describes a method for producing an active matrix liquid crystal display screen (“TFT” or thin film transistor screen). The display screen has a diffuser placed on the interior face of one of the glass plates. The diffuser is a replica of a holographic diffuser; it is produced by forming an organo-silane adhesion layer on the glass. A photopolymerisable monomer is placed on the adhesion layer. A holographic diffuser used as a mould is placed in contact with the photopolymer. After exposure to ultraviolet light, the holographic diffuser is removed. A planarazing layer (fluoropolymer or polyimide) is then applied over the hardened photopolymer.

U.S. Pat. No. 5,870,224 describes a display screen with a lenticular support.

There is still a need for a display screen having contrast characteristics as good as those of WO-A-00 67071, but which is even simpler to manufacture.

The invention thus proposes, in one embodiment, a display screen comprising a support with focusing elements, a diffuser fixed to the support and having an active surface directed away from the support and located substantially in the focal plane of the focusing elements; an opaque layer with a thickness less than 20 μm having openings adapted to let through light focused by the focusing elements. The diffuser is preferably an active surface diffuser.

Advantageously, the opaque layer has a thickness less than 10 micrometers, preferably less than 5 micrometers, or even 2 micrometers.

It is also advantageous if the openings in the opaque layer have a surface area less than 10% or even 5% of the total surface area of the screen.

The opaque layer may be deposited on the active face of the diffuser.

One may also provide, on the active face of the diffuser, a layer with a refractive index higher than the refractive index of said diffuser. In this case, the layer with a higher refractive index comprises, for example, a dielectric material, a polymer or an organic-inorganic hybrid made by sol-gel process.

The opaque layer can then extend above the layer of higher refractive index.

One can also provide, on the active face of the diffuser, a protective layer and arrange the opaque layer on top of the protective layer. In this case, one can provide, on the opaque layer, a layer with a refractive index higher than the refractive index of the diffuser.

In a preferred embodiment, the diffuser is a holographic diffuser.

In another embodiment, the diffuser is an active surface diffuser. It is then advantageous for the screen also to have a substrate bonded against the opaque layer by a layer of adhesive. One may provide for the thickness of the opaque layer to be higher than the thickness by which the adhesive layer extends out into an opening.

The invention also proposes a method for producing a display screen, comprising the steps of:
providing a support with focusing elements;
providing a diffuser having an active face;
applying the diffuser against the support with the active face thereof directed away from the support and substantially in the focal plane of the focusing elements;
forming an opaque layer of a thickness less than 20 μm;
forming openings in the opaque layer by irradiation through the focusing elements of the diffuser.

The irradiation step may comprise laser irradiation.

The step of forming an opaque layer may also comprise the formation of an opaque layer on the active face of the diffuser.

One can also form, on the active face of the diffuser, a layer having a higher refractive index than that of the diffuser and form an opaque layer on the layer of higher refractive index.

Alternatively, one can form, on the active face of the diffuser, a protective layer and the step of forming an opaque layer then comprises forming an opaque layer on the protective layer.

In this case, one can also form, on the opaque layer, a layer of higher refractive index than that of the diffuser.

The diffuser may be a holographic diffuser. This diffuser may be obtained by:
forming a layer in a photohardening material;
applying a master holographic diffuser with the active face thereof against the layer in a photohardening material;
irradiating the photohardening material, and
removing the master holographic diffuser.

This process may also be applied for manufacturing another type of active surface diffuser; one may also replicate an active surface diffuser on the surface of the substrate opposite to the focusing elements. Also, the focusing elements could be formed by replication on the substrate.

In another embodiment, the diffuser is an active surface diffuser. One may then provide for a step of applying a substrate bonded beforehand against the opaque layer.

Other characteristics and advantages of the invention will become clear in the description that follows of the various embodiments of the invention, which are given by way of example, and by referring to the figures which show:

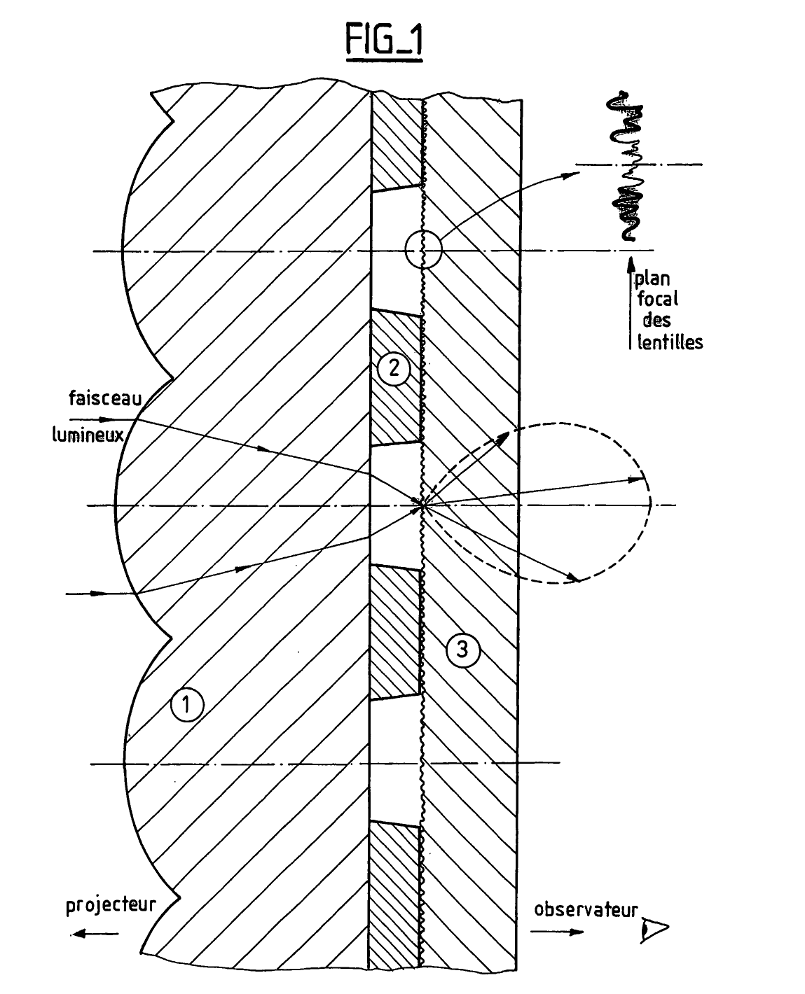

FIG. 1: holographic type display screen according to the invention;

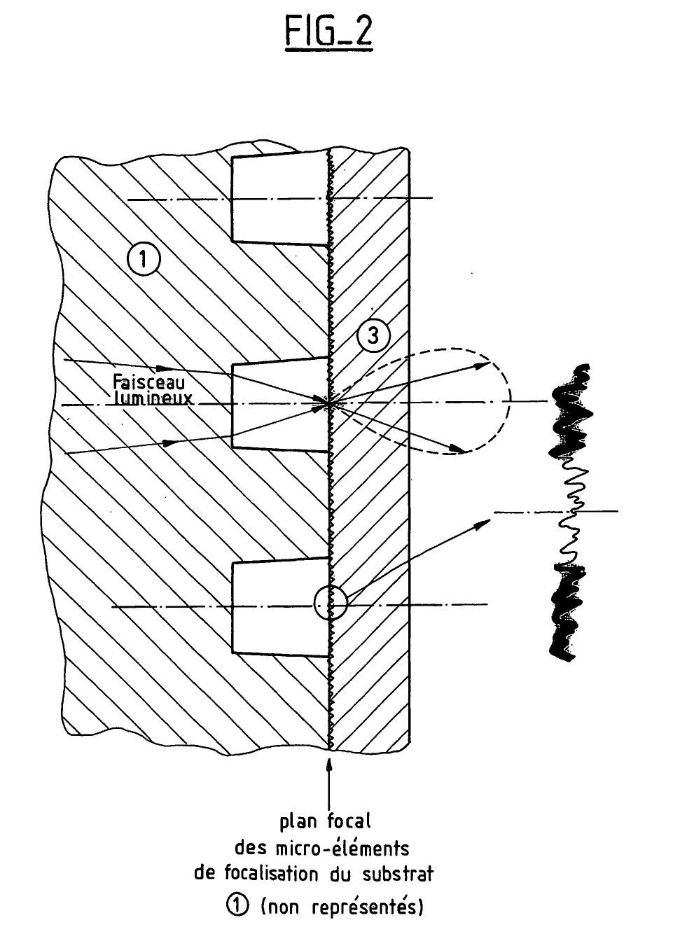

FIG. 2: another holographic type display screen according to the invention;

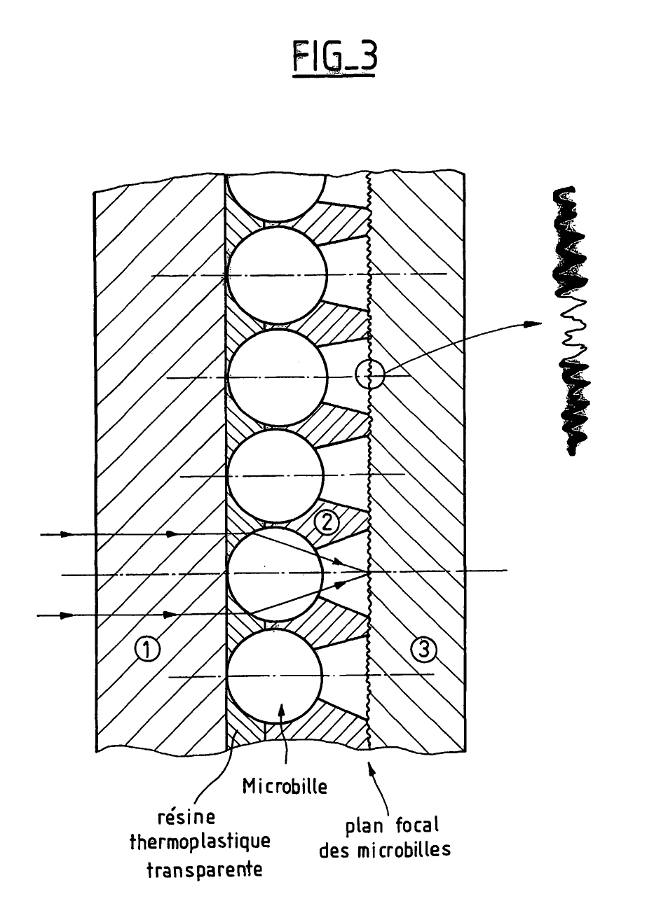

FIG. 3: holographic type display screen with micro-beads as focusing elements;

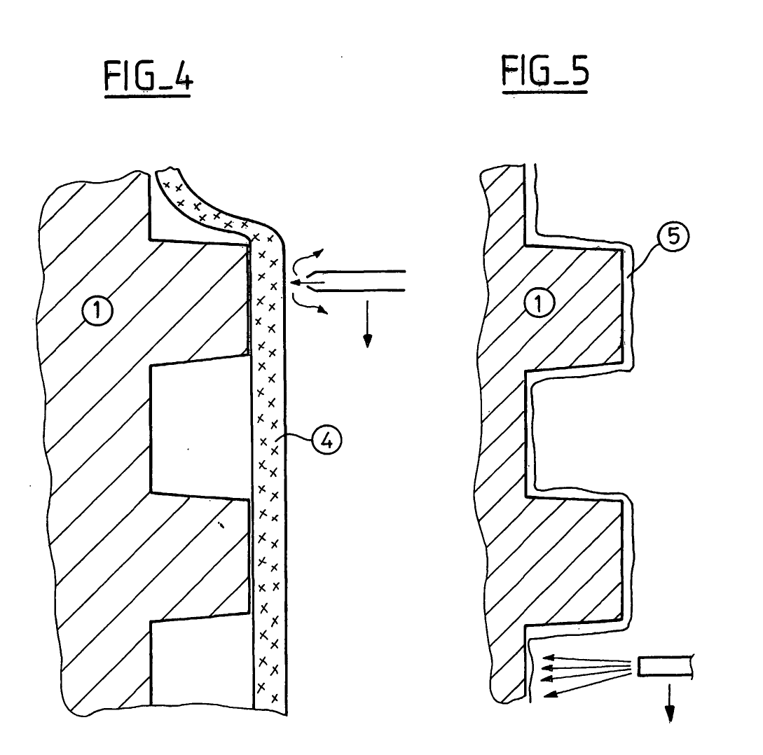

FIGS. 4 and 5: different methods of bonding the holographic diffuser onto the substrate;

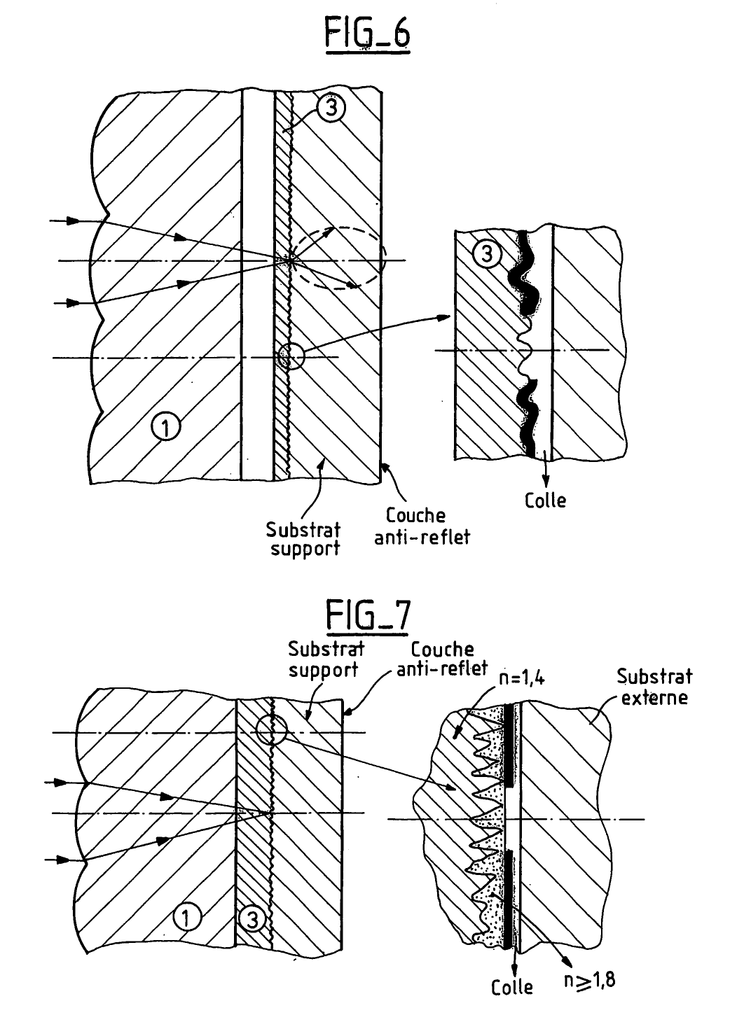

FIG. 6: very high contrast display screen with classical diffuser;

FIG. 7: holographic display screen with a structure similar to the display screen shown in FIG. 6.

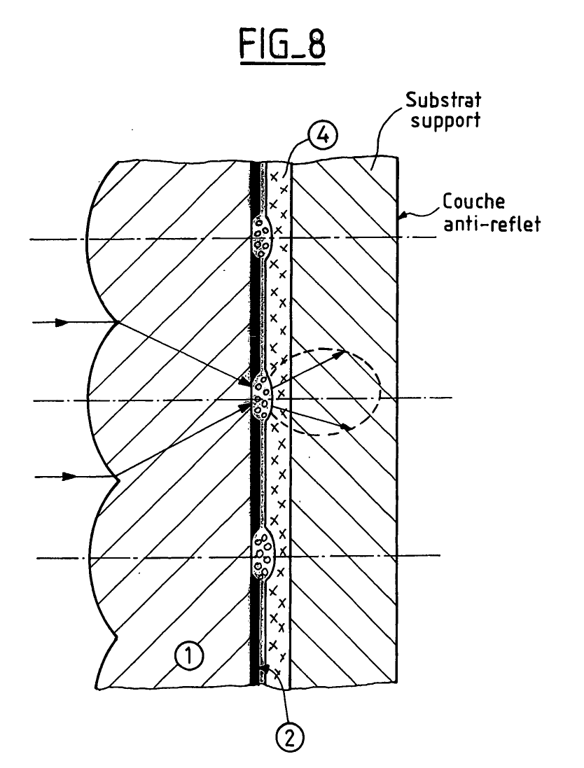

FIG. 8: high contrast display screen with a diffusing structure of micro-beads with a diameter of several microns.

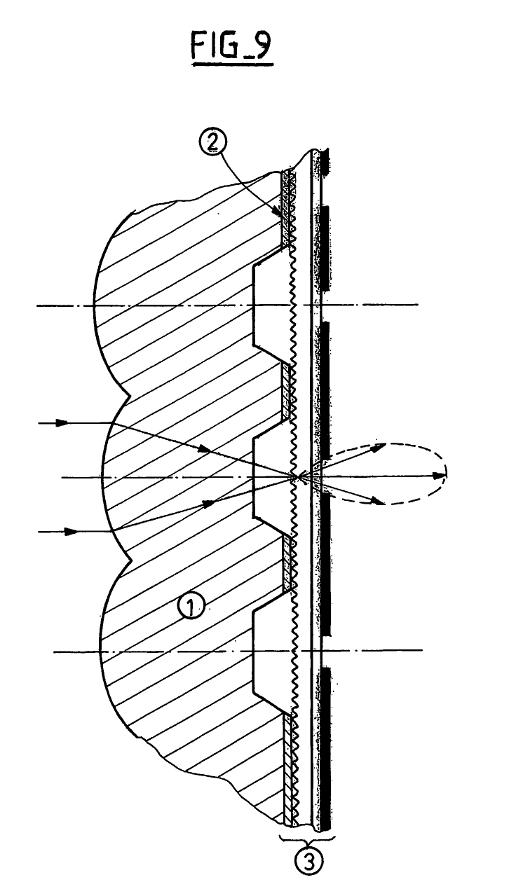

FIG. 9: yet another screen with a holographic type diffuser according to the invention.

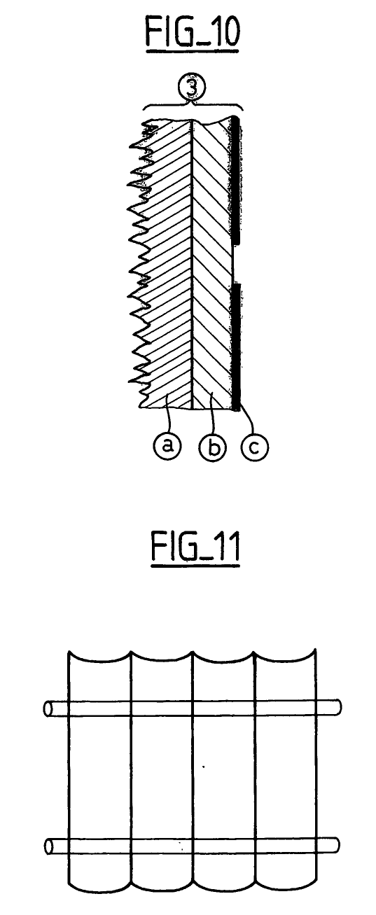

FIG. 10: larger scale schematic cross sectional view of the diffuser of the screen in FIG. 9;

FIG. 11: schematic perspective view of a part of the screen;

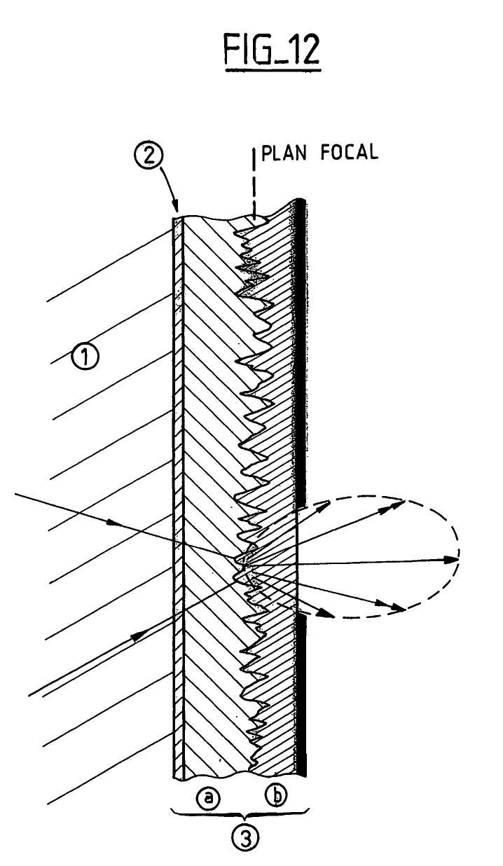

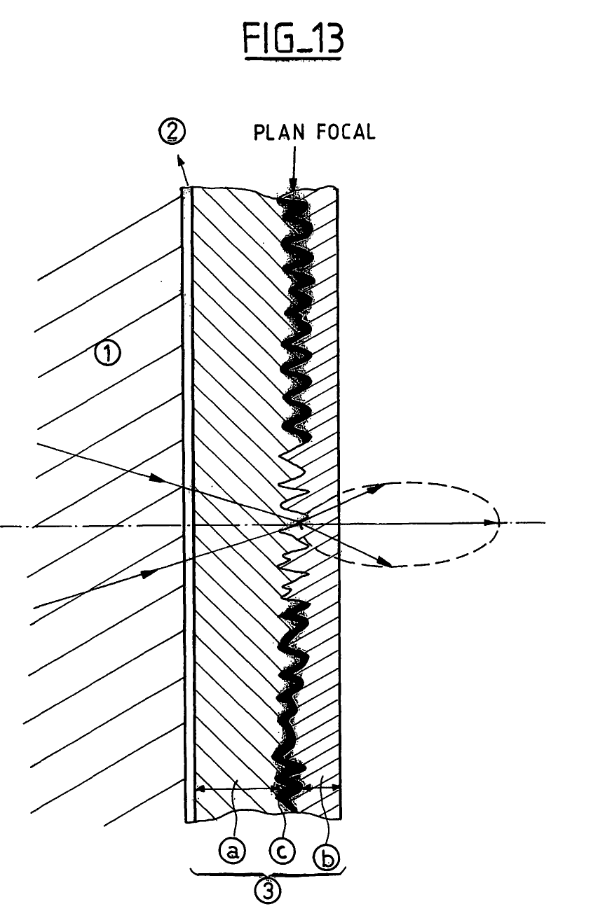

FIGS. 12 and 13: schematic cross sectional views of other screens;

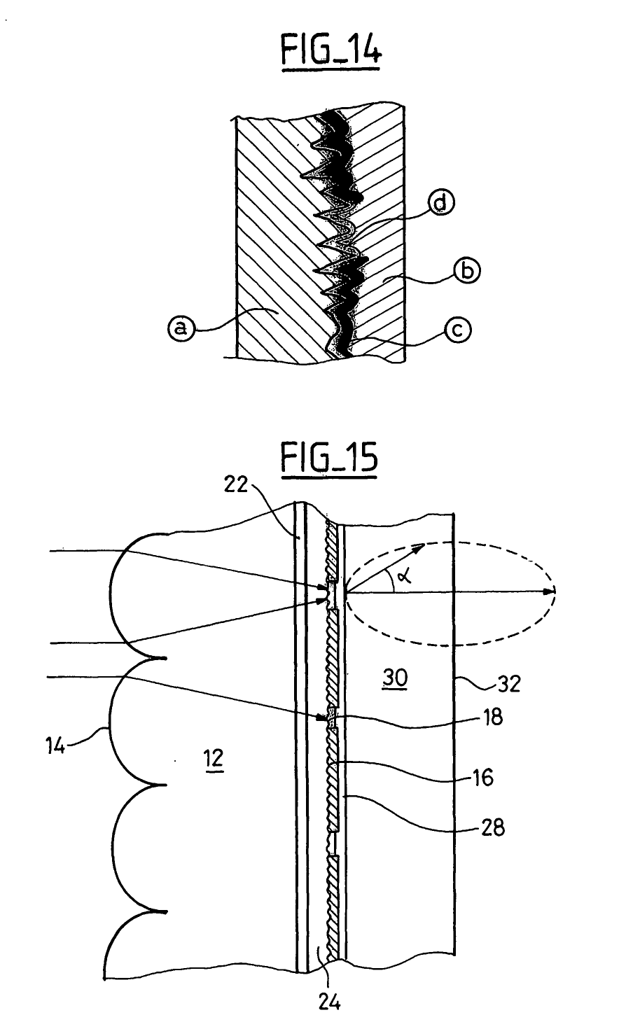

FIG. 14: another example of a holographic diffuser;

FIG. 15: a cross sectional view of another screen;

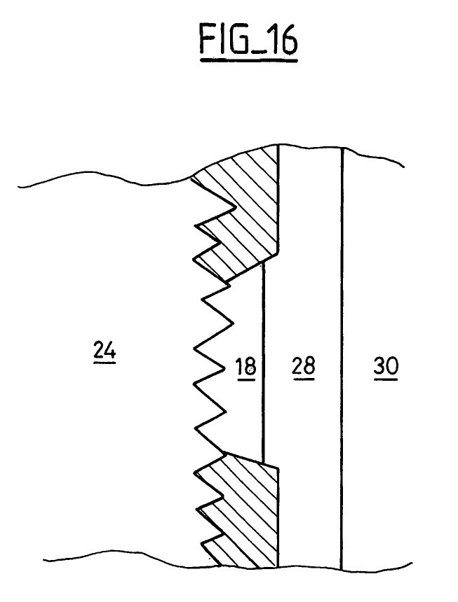

FIG. 16: a larger scale view of part of FIG. 15;

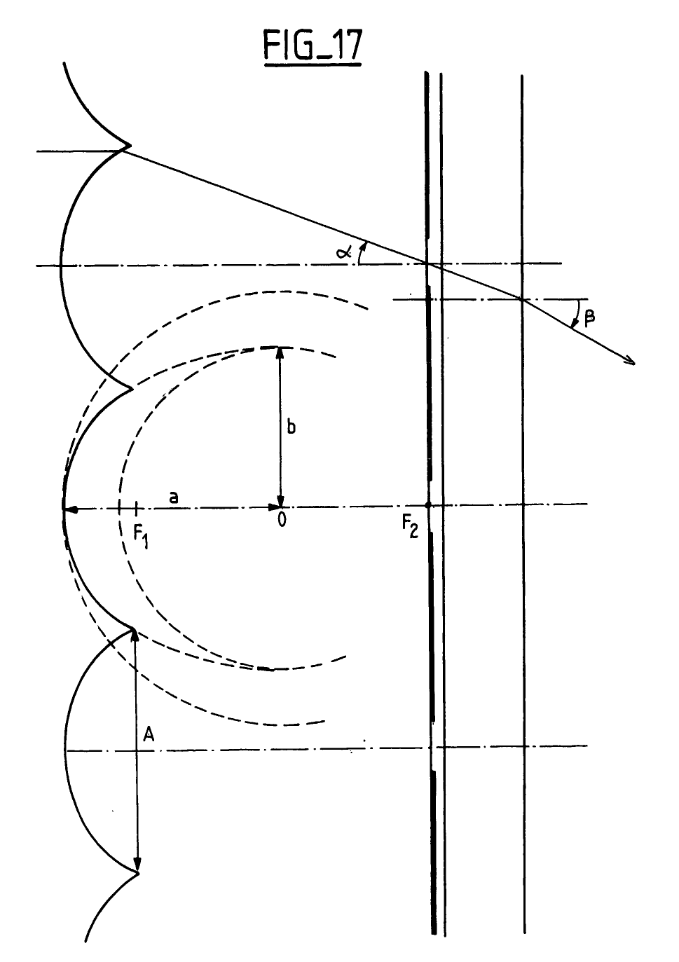

FIG. 17: a cross sectional view of aspheric focusing elements.

The characteristics of the display screen are a very high contrast (C>500) and optical transmission (T≧0.75 or 0.70), high resolution if necessary for the targeted application, a light emission with controlled directivity, increasing the luminance of the display screen for viewing angles that interest the application. At the output of the Fresnel optic of the rear projector, the display screen receives a collimated luminous flux that it focuses via a multitude of focusing elements in the openings made in an opaque layer leading to, at the output of this opaque layer, a light emission with controlled directivity. The focusing elements are micro-lenses, lenticulars or micro-beads.

The rear projection viewing angles specification may be related to the application: television does not need wide vertical viewing angle, so the rear screens for TV are typically, at half-luminance, ±35° horizontal and ±10° vertical. Monitors need high viewing angles in both directions, e.g. at half-luminance, ±40° horizontal and vertical. Consequently, TV screens featuring higher gain, less lumens are needed than in the case of a low gain screen. The invention is compatible with both options:
a) the diffuser is the main contributor to the viewing angles associated with a cylindrical lenticular support 1 featuring a relative high thickness. For television, the diffuser may notably be a holographic diffuser (for example the one referenced LSD 95°×25° of the POC company) or a surface relief diffuser (SRD of the REFEXITE Display Optics Company).
b) the diffuser and the support are co-contributors to the viewing angles. The diffuser could be a symmetric either holographic or surface relief diffuser featuring a diffusing angle close to the vertical screen viewing angle. Then the lenticulars of the support 1 are preferably aspherical to contribute with the diffuser to the horizontal viewing angle; for example see the example discussed below in relation with the FIG. 17: in cross section, the aspherical shape of the lenticular lenses is an ellipsis, whose eccentricity is equal to the reciprocal of the optical index of the lens medium n1; this leads to minimizing the aberrations of the lenses and then enables to get an aperture ratio X below 10% in the black layer. One can choose the parameters a=0.135 mm and b=0.100 mm for the ellipsis, leading with n1=1.5 to the focus point position OF2=OF1=0.090 mm; the width of the lenticular lenses is chosen A=0.150 mm compatible with high resolution; as the lenticular lenses are vertical, the maximum horizontal viewing angle β of the screen of the FIG. 17 without the diffuser is related to h=A/2=0.075 mm: the angle α value is 22° and as sinβ=n1×sinα, β=34° (half-angle=17°).

Then associated with a diffuser featuring a half-angle at 10° corresponding to the vertical viewing angle of the screen, the horizontal viewing half-angle of the screen is equal to:
((10)\hat{ }2+(17)\hat{ }2)\hat{ }0.5=20°
this screen with viewing half-angles at 10° in vertical and 20° in horizontal could be dedicated to television.

In the rest of the description, some examples, such as the ones of FIGS. 7, 9, 12, 13 and 14 refer to an holographic diffuser. More generally, one could use another type of active surface diffuser. Generally speaking, an active surface active diffuser could be defined as a continuous complex surface which separates two transparent medium with different optical indexes n1 and n2; diffusers according the embodiments of this invention includes notably holographic diffusers or surface relief diffusers as surface active diffusers.

The contrast of the screen may be defined as follows. The contrast is related to the luminous flux F in lumen of the projector, the ambient lighting E in lux, the optical transmission T in % of the screen, the diffuse reflectance R in % of the screen, the gain G of the screen compared to a lambertien one, the surface S of the screen, by the following relation:
C=F/E×T/R×G/S
R=R1+R2 with
R1 as the reflectance of the anti-reflection coating on the external surface of the screen
R2=Ro×X % with Ro as the reflectance of the diffuser and X % is the ratio of the openings in the black layer versus the total surface area of the screen.
   Considering: a Moth-eye anti-reflecting coating with R1=1%; Ro is below 3% for an active surface diffuser; an aperture ratio X %=20% as a pessimistic value for the contraste; then R=1.6% .

With the case of F=500 lumens, E=100 lux, G=2.5 corresponding to an assymetrical light emission by the screen, S=1 m\hat{ }2, then the contrast is:
C=500/100×70/1.6×2.5/1=550
For the television market, as the screen gain G is targeted above 5, an aperture ratio X % up to 30% with such a screen technology is still compatible with a contrast C>500 for a luminous flux F>300 lumens.

FIG. 1 illustrates the principle of the very high contrast holographic type display screen, according to one embodiment of the invention. The substrate 1 with micro-focusing elements comprises a thick layer 2 with wide openings. The sum of the thicknesses of the substrate 1 and the layer 2 is equal to, or very close to, the focal length of the micro-focusing elements of substrate 1.

The holographic diffuser 3, blackened on its entire active surface except at the focal points of said micro-focusing elements of substrate 1, is bonded onto the external face of said layer 2. At the focal points, the holographic diffuser has, in the openings of the black micro-layer, an active surface area less than 10% or even 5% of the total surface area of the display screen. Thus, the holographic diffuser has its active face directed towards the projector as specified by the manufacturer; with the active face directed back to front towards the observer, the holographic diffuser emits abnormally elevated light at elevated angle, compared to the normal angle, to the detriment of the intermediate angles.

The openings of the black micro-layer made on the active surface of the holographic diffuser are thus in contact with an air space; this protects the active holographic layer in the openings of the black micro-layer from coming into contact with the adhesive which would destroy its diffusing properties with the undesirable generation of “hot spots” in the transmitted images.

On the outside, towards the observer, the display screen may be coated with an anti-reflective layer, Moth-eye microstructure or evaporated thin film or thin film made by sol-gel process.

This holographic type display screen is very innovative compared to the prior art in which the holographic layer is bonded onto a tinted substrate with optical transmission T=0.5, which leads to a limited optical output ratio and display screen contrast.

A method for producing the display screen in FIG. 1 is as follows.

On the substrate I provided with micro-lenses or lenticulars on one face of thickness less than several tens of microns at the focal length of the focusing elements, is applied using known means (screen printing, etc.) a layer of black ink with a thickness of several tens of microns; the wide openings in the black layer 2 are produced for example by irradiation with a YAG laser (λ=1060 nm) focused by the focusing elements which concentrate the YAG energy in the black layer, causing the local atomisation of this black layer in the form of dust and smoke; the width of the openings is obtained by widening the YAG irradiation cone of the focusing elements.

Another method for producing the layer 2 is to apply a thick coat of positive photosensitive resin onto the substrate 1 and to irradiate it with U.V. rays through the focusing elements, then to develop it in order to generate grooves or cavities around the focal points.

Another method for producing the layer 2 consists in coating onto the substrate I a thick layer of a low melting point (<100° C.) thermoplastic resin filled with graphite and therefore opaque; then making openings (grooves or cavities) by YAG laser irradiation focused by the focusing elements; the blackened holographic diffuser is then bonded by simple hot lamination onto said layer 2.

Another method for producing the layer 2 consists in applying a thick layer of graphite filled and therefore opaque liquid adhesive then, after drying, irradiating it with the YAG laser focused by the micro-elements in order to form the openings in said layer 2. An aqueous adhesive is well suited to this purpose. The diffuser 3 is then laminated onto the adhesive provided with said openings.

In all cases, the openings in the thick layer are wide, compared to the focusing of the focusing elements. In the case of focusing elements along a single dimension—grooves or lenticular screens—the dimension of the openings in the thick layer may attain 50% of the surface area of the thick layer (or more exactly the total surface area of the display screen). A dimension greater than 20, or even 30% is appropriate.

In the case of focusing elements along two dimensions—micro-lenses, micro-beads or others—the dimension of the openings in the thick layer may attain 50% of the surface area of the thick layer (or more exactly, the total surface area of the display screen). A dimension greater than 15, or even 20% is appropriate.

The openings in the thick layer may thus be obtained easily, without the need for specific precautions during production. Compared to the solution proposed in WO-A-00 67071, the production is simpler; it will be recalled that the openings proposed in this document have a surface area of 10%, or even less than 5% of the black layer.

Moreover, the active surface of the holographic diffuser is blackened using known techniques, such as ink jet, flexographic or screen printing, etc.

The black micro-layer on the active holographic surface is very thin, having a thickness of around 1 μm typically to several microns at the most, just hugging the roughness of the active surface in order to limit the amount of black material that has to be atomised later in the form of dust and smoke. The holographic diffuser blackened in this way is bonded onto the external layer 2, while avoiding any contact of the adhesive with the active holographic surface that is still blackened at this stage. Suitable bonding methods are described hereafter in FIGS. 4 and 5 and above.

Finally, the small openings in the region of the focal points are generated in the black micro-layer applied onto the holographic surface by another YAG laser irradiation focused by the micro-focusing elements. Under the effects of the focused laser beam, the black micro-layer is atomised in the adjacent air space defined by the openings (grooves or cavities) of layer 2. The dust from the atomisation is re-deposited on the surfaces circumscribing the air space that are much larger (in most cases, at least ten times larger) than the surface area of the openings made in the black micro-layer formed on the holographic surface. As a result, the re-deposition of dust does not generate a significant neutral filter in the path of the light beam and thus practically does not reduce the optical transmission of the display screen.

In the case of lenticular elements that generate grooves in said layer 2 emerging from the two sides of the substrate, it is possible to avoid any re-deposition of dust by micro-circulating compressed air in the grooves of layer 2 during the irradiation or YAG laser exposure of the black micro-layer applied on the holographic surface.

An alternative solution consists in fixing the diffuser to the substrate uniquely on the edges, using wedges, while providing a space between the diffuser and the substrate. If the black layer is directed towards said space, as in the examples in FIG. 1, 2 and 3, one can introduce into said space a sheet, having a roughness, with said roughness directed towards the black layer. One then forms the openings in the black layer, for example by using a laser. The dust liberated by the irradiation of the black layer at the focal points is deposited on the sheet, the roughness of said sheet contributing to the collection of the dust. One can carry out an irradiation in several steps, changing if necessary the sheet at each step; changing the sheet in this way avoids limiting the power as a result of absorption by the dust liberated by the previous irradiation. In another technical field, an analogous principle is applied in laser printers, where the receiver paper, the copy, receives black dust coming from a donor film under the effects of a laser beam; the same is true for the special surface-treated paper that absorbs the ink in ink jet printers.

Finally, the display screen may be provided with an anti-reflective layer or bonded onto a transparent support, itself provided with an external anti-reflective layer towards the observer.

To resume, the grooved or cavitied layer 2 only acts as a support and a protection, by the air spaces, for the holographic surface; this layer is not necessarily black, as explained in reference to FIG. 2. The high contrast is obtained by the black micro-layer formed directly on the holographic surface opened up, at the minimum, at the focal points for letting through light. One thus separates the two functions of the black layer of document WO-A-00 67071:
to ensure the presence of air in the region of the points of the holographic diffuser through which the light is directed towards the observer; and
to limit the contrast by blocking the light around these points for letting through light.

The first function is assured by the thick layer; this mechanical function is obtained by a production with wider tolerances. The second function is assured by the thin black layer deposited on the holographic display screen. This optical function is easily obtained, due to the low thickness of the corresponding black layer.

FIG. 2 shows an alternative embodiment of the holographic display screen shown in FIG. 1 in that the deposition of the grooved or cavitied layer 2 is no longer necessary: the substrate 1 is provided directly on the face directed away from the focusing elements with grooves or cavities formed according to the prior art (moulding; extrusion; thermoforming, etc.); this is possible due to the very large tolerance regarding the positioning of said grooves or cavities in relation to the focusing elements. In other words, the large sized openings in layer 2 in FIG. 1 are made directly in the substrate 1. In so far as these openings only have a mechanical function, it is not necessary for them to be made in a black or opaque layer.

In order to illustrate the dimensions of the microstructures of the display screen, we will take for example a resolution of 40 l.p.i. (lines per inch or 25.4 mm):
periodicity and size of the focusing elements=640 microns;
focal length=2.2 mm;
thickness of layer 2 in FIG. 1: several tens of microns −20 to 50 μm for example;
size of the openings in layer 2 in FIG. 1: 300 microns for example;
thickness of the black micro-layer on the holographic surface: around one micron;
size of the openings in the black micro-layer=less than 32 μm or, at the most, 64 μm in the case of grooves (focusing lenticulars), less than 140 μm or at the most 210 μm in the case of cavities (focusing micro-lenses);
depth of the grooves or cavities in the substrate 1 in FIG. 2: up to 500 μm;
size of the grooves or cavities in FIG. 2: 300 μm for example.

It will be observed, as explained above, that the openings in the layer 2 in FIG. 1 or the grooves or cavities in FIG. 2 have larger dimensions than the openings in the black layer on the holographic diffuser.

FIG. 3 shows the new holographic display screen with micro-beads as focusing elements.

The transparent substrate 1 with parallel faces acts as a support for the whole assembly. The micro-beads are bonded onto the substrate 1 according to the technique described in the Kodak-Pathé FR-A-959 731 patent dated the Oct. 10, 1949, apart from the fact that the thermoplastic resin for bonding said beads is not blackened or graphited but remains transparent.

As regards the layer 2 and the blackened holographic diffuser 3, everything is identical to that described here above (FIGS. 1 and 2).

The refractive index of the micro-beads is chosen to be close to that of the thermoplastic adhesive in order to result in a longer focal length, enabling said layer 2 to have a consequent thickness; this simplifies the creation of wide openings in said layer and strengthens the cohesion of the assembly for the subsequent bonding of the diffuser 3.

We will now describe, in reference to FIGS. 4 and 5, various methods for bonding the holographic diffuser 4. These methods apply to the bonding of a holographic diffuser for the production of the display screens represented in FIGS. 1 to 3. They also apply to the bonding of a holographic display screen for the display screen described in WO-A-00 67071. The principle of coating the upper surface with several microns of adhesive by flexographic printing is very suitable: the grooved coating cylinder deposits a calibrated thickness of adhesive onto the upper surface without depositing adhesive in the engravings. This is more advantageous than screen printing, which leads to a uniform deposition of adhesive and a possible filling of the holes.

FIG. 4 represents another bonding principle for the holographic diffuser 3.

The high transparency film 4 is further used to bond the different stages of liquid crystal TV screens. The adhesive film 4 of standard thickness (12 μm; 25 μm, etc.) is laminated onto the substrate 1 coated on not with layer 2—substrate of FIG. 1, of FIG. 2 or of FIG. 3. Then, the film 4 stretched over the grooved structure or structure with cavities/bosses is torn and driven into the grooves or cavities in the substrate 1 by blowing compressed air while sweeping over the whole surface. At the summit of the bosses, the film 4 is maintained. Finally, the holographic diffuser 3 is bonded by lamination without the film 4 coming into contact with the active holographic surface, in the region of the points for letting light through towards the observer. Since the film is transparent, the presence of the film or fragments of films in the openings of the substrate I or the layer 2 is not a problem.

A low melting point (80° C.) EVA (ethyl vinyl acetate) type thermoplastic film may replace the adhesive film 4. After blowing to tear and drive in the thermoplastic film, the diffuser 3 is hot laminated (80° C.) onto the thermoplastic film 4 maintained on the bosses of the substrate 1. This is possible given the temperature resistance of the holographic diffuser 3: 100° C. for 240 hours.

FIG. 5 shows the principle of bonding the diffuser 3 by micro-spraying liquid adhesive or other adhesives.

A fine layer of adhesive 5, around one micron or several microns thick, is applied onto the substrate 1 or the grooved or cavitied layer 2 by micro-spraying that sweeps over the whole surface.

This adhesive layer may be:
a simple aqueous adhesive;
a thermoplastic adhesive on which the diffuser 3 will be hot laminated;
a U.V. adhesive; firstly, it is polymerised in the grooves or cavities by U.V. irradiation focused by the focusing elements; secondly, the diffuser 3 is laminated onto the substrate 1 under general U.V. irradiation (under all angles) through the substrate 1 in order to polymerise the adhesive between the bosses of the substrate 1 and the diffuser 3;
a microencapsulated adhesive (capsules with a diameter of around several microns); under the laminating pressure, these capsules burst between the bosses of the substrate 1 and the diffuser 3 liberating adhesive; at the bottom of the grooves or cavities, the capsules are not subject to any pressure, the adhesive is not liberated and the active surface of the diffuser 3 is thus preserved; the microencapsulated adhesive may advantageously be a U.V. type in order to combine the pressure effects on the bosses and U.V. hardening in the grooves or cavities.

Holographic diffusers and surface relief diffusers diffuse light as a result of only the roughness of the surface active. In the case of a classical diffuser, the diffusion of light takes place in a layer, several microns to several tens of microns thick, applied onto a transparent support.

FIG. 6 shows the very high contrast and very high optical transmission display screen with a classical diffuser. The substrate 1 does not have a grooved microstructure; the support of the classical diffuser 3 is bonded or laminated onto the substrate 1. A black micro-layer is applied onto the external surface of the diffuser 3 which is located in the focal plane of the focusing elements of the substrate 1. The openings for letting through light are formed by YAG laser irradiation focused by the lenses; the surface area of these openings represents at the most 5 to 10% of the total surface area of the display screen. A substrate coated with an anti-reflective layer may be bonded directly onto the blackened diffuser 3 to act as a support.

FIG. 7 shows a holographic diffuser display screen that is similar to the display screen structure shown in FIG. 6.

The holographic diffuser 3 is bonded back to front on the substrate I without a grooved structure; in order to re-establish the correct emissivity of the holographic layer with the light coming from the low refractive index towards the high refractive index, the roughness of the holographic layer is filled and levelled off with a layer with a higher refractive index. This layer may be produced by reactive plasma using low temperature (<60° C.) and high output (deposition rate: 5000 Å/min) plasma equipment.

In this case, the indices may be the following:
refractive index of the diffuser 3: 1.4
refractive index of the evaporated layer:
   1.9 for a layer of Si₃N₄
   2.2 for a layer of TiO₂
   2.2 for a layer of Ta₂O₅

The levelling layer could be also an organic-inorganic hybrid made by the cost effective sol-gel process. A layer with a refractive index higher than 1.8 is achievable: a metal alkoxide gel is after hydrolysis applied by screen printing on the diffuser surface with an UV curable binder resin; under radiation the metal oxide gel is realized simultaneously with the hardening of the binder resin. Ta2O5 is convenient as metal oxide.

The presence of the layer with a higher refractive index ensures the holographic diffuser operates correctly—despite the absence of air in front of the active part of the diffuser.

The external black micro-layer responsible for the high contrast is produced and applied as in the example of FIG. 6.

A support substrate coated with an anti-reflective layer may be bonded directly onto the blackened diffuser.

FIG. 8 shows a high contrast display screen with a diffusing structure of micro-beads.

The substrate 1 is coated with a thin black layer (thickness <20 μm) having openings at the position of the focal points of the micro-lenses or lenticulars of the substrate 1. The surface area of these openings is less than 5 to 10% of the total surface area of the display screen. A layer of glass or plastic micro-beads with a diameter of several microns is applied over the whole surface by screen printing using a U.V. adhesive as a binder.

Under U.V. exposure, focused by the focusing elements of substrate 1, the U.V. adhesive is polymerised in the openings of layer 2 causing the hardening and the maintaining of the layer of micro-beads in the openings. On the black layer, since the U.V. adhesive is not polymerised due to the absence of U.V., the layer of micro-beads may be removed and recovered. The directivity of light emission by the display screen is linked to the refractive index of the micro-beads, the thickness of the layer of micro-beads in the openings in said layer 2.

The display screen may be bonded onto an external support using a transparent adhesive film (identical to the adhesive film 4 in FIG. 4) or standard transparent liquid adhesive that is compatible with the materials.

The display screen in FIG. 8 may also, due to the photopolymerisation method used, be envisaged for colour by using coloured micro-beads; in this case, the projector only transmits white light towards the “colour” screen.

The method for producing the “colour” display screen is sequential, like the method used for producing TV screens.

The display screen in FIG. 8 may also be constructed in a sequential manner to end up emitting light with variable directivity from the centre towards the edges, for example; to do this, the sequences for producing the screen make use of micro-beads with different indices and micro-layers of different thickness.

We will now describe, in reference to FIGS. 9 and the following Figures, other examples of screens having holographic diffusers. These diffusers may be used with screens of the type described in reference to FIGS. 1 to 8; one could also use these diffusers with other screens, for example those of document WO-A-00 67071.

FIG. 9 shows a schematic cross sectional view of a display screen with a holographic diffuser; one can see in FIG. 1 the substrate 1 with the focusing elements, and the openings in the region of the focal points. The Figure also shows a layer of adhesive 2, and a holographic diffuser coated with a black layer; the diffuser and black layer assembly is referenced 3 and shown in larger scale in FIG. 10. As in the example in FIG. 1, the holographic diffuser is directed towards the openings in the substrate. However, the black layer is put on the outside of the diffuser, in other words the side of the diffuser that is directed away from the substrate. This is made possible by the low thickness of the diffuser.

The advantages of the examples in FIGS. 9 and 10 are as follows: since the diffuser can be very thin—with a thickness typically less than 20 microns—it enables openings to be formed at the focal points in the black layer, while limiting the surface area of said openings. The low thickness of the diffuser limits the diffusion of the laser that is used to form the openings. Moreover, in order to improve the efficiency, the irradiating beam operates above a threshold power density (in w/cm²): this is facilitated by the low thickness of the diffuser. In fact, with a high thickness, the power density on the edges of the engraving would lose efficiency, leading to too small an opening and thus to a light absorption filter at the edges and therefore a loss in luminous efficiency and a limitation of the diffusion angle of the screen. One can provide an external black layer of around one micron that is opened up, at the focal points, by YAG laser; the surface area of the openings may be less than 5 to 10% of the total surface area—black layer and openings.

FIG. 10 shows a larger scale view of the diffuser and black layer assembly. This assembly comprises a support (b), a layer (a) in which is arranged the holographic surface. The black layer (c) is provided on the side directed away from the support. The assembly in FIG. 10 may be produced by replication of a master holographic surface, by exposure of a photopolymer in contact with the master holographic surface.

To this end, one places a photopolymer on the transparent polyester support (b) moreover with a thickness typically of 1 to less than 20 microns. The support (b) is provided, if necessary, with an adhesion promoter for the photopolymer of the layer (a). One applies a master holographic surface on the non-hardened photopolymer and one then exposes the photopolymer through the holographic surface or through the support (b). One then removes the master holographic surface and one obtains a diffuser assembly formed from the support (b) and the holographic layer.

The black layer (c) of thickness around one micron is produced by screen printing, ink jet, flexographic printing, etc. One may use any of the techniques mentioned here above.

The diffuser (3) is bonded onto the substrate (1) by a layer of adhesive (2) applied, for example, by flexographic printing. As explained here above, the holographic surface does not come into contact with the adhesive, due to the openings made in the substrate.

The openings in the black layer (c) are finally made, after bonding the diffuser (3), by irradiation focused by the focusing elements (1). This irradiation is facilitated by the low thickness of the diffuser.

If one uses a substrate having grooves, the diffuser (3) may be bonded over its whole surface. This leads to a mechanical rigidity which then enables the bonding on the general support—with a thickness typically greater than or equal to 4 mm. This support may be provided with an external anti-reflective layer, which improves the blackness of the screen. One may also provide such a support for focusing elements other than grooves.

FIG. 11 shows a schematic perspective view of part of a screen; we have only represented the support in the Figure. This has focusing elements in the form of grooves. Thin blackened cylinders are bonded onto the surface of the support, at right angles to the focusing elements and spaced several millimetres apart. This value is sufficiently low to ensure the rigidity of the diffuser and substrate assembly; it is sufficiently high so as not to affect the transmission of images through the screen.

The cylinders or bars are blackened to absorb the light—for example the laser beam—used for engraving the black layer. One thus avoids destroying the black layer at the contact point with the cylinders, and allowing the image to pass through which would diffuse through the cylinders. One also avoids destroying the hologram by the laser beam. One avoids the phenomenon of “hot spots” or contact of adhesive with the diffuser (3) in the case of a holographic diffuser. The bars may, for example, be coloured within the bulk.

The example in FIG. 11 makes it possible to facilitate the production of the substrate. In fact, the production of the substrate assumes a given relative position of the face of the substrate having focusing elements and the face of the substrate having openings. For example, if one considers lenses with a diameter of 400 μm or grooves with a period of around 400 μm, the openings on the other surface of the substrate have a dimension of around 200 μm and the tolerance of the positioning of the openings compared to the grooves, or of one surface of the substrate compared to the other surface of the substrate, is around 100 μm.

In the example in FIG. 11, one only has to place the cylinders acting as separators or dividers, without their positioning having a significant effect. In fact, in the case of cylinders with a diameter of 200 to 400 μm, separated by 5 mm, the cylinders only take up 4 to 8% of the total surface area of the screen. The reduction in luminous intensity due to the separators or dividers is not nullifying due to the very high contrast provided by the screen. The solution in FIG. 11 eliminates any problems of tolerance regarding the positioning of the focusing elements on one of the surfaces of the substrate compared to the openings on the other surface of the substrate. As a result, the surface of the substrate 1 on which the separators or dividers are placed may be a smooth surface.

In the example in FIG. 11, we considered focusing elements in the form of grooves. The proposed solution also applies to other forms of focusing elements. Finally, we have mentioned a holographic diffuser, but the solution in FIG. 11 also applies to other types of diffusers.

One could also use separators having another shape, such as for example calibrated beads, with the diffuser and the substrate being fixed uniquely on the edges of the screen.

FIG. 12 is a schematic view of another holographic diffuser screen. The screen in FIG. 12 is similar to that in FIG. 7; one can recognise substrate 1, the focusing elements of which are not shown. The diffuser 3 is bonded onto the substrate 1 by an adhesive 2 or replicated directly on the rear face of the substrate 1. The screen diffuser in FIG. 12 differs from that in FIG. 7 in that the higher refractive index layer (b) is a polymer layer with a higher refractive index instead of an evaporated layer of dielectric material. The polymer layer is simply formed by screen printing, flexographic printing, etc.

The holographic diffusing surface at the interface of the holographic diffuser (a) and the polymer layer (b) with a higher refractive index is located in the focal plane of the focusing elements of the substrate (1).

On the other hand, for the reasons explained here above for the screen in FIG. 1 or the screen in FIG. 9, the thickness of the polymer (b) is also limited as much as possible and typically less than 20 microns. The black layer is very thin, around one micron. One can form the diffuser (a) as explained in reference to. FIG. 9. For example, the layer (a) may be an inexpensive replication in silicone with a refractive index of 1.4 and the polymer (b) a polyimide with a refractive index of 1.8. An adhesion promoter may be used between the holographic diffuser (a) and the polymer with higher refractive index (b).

FIG. 13 shows another example of a holographic diffuser screen. The screen is similar to that shown in FIG. 12, except that the black layer (c) is positioned between the diffuser (a) and the higher refractive index layer (b). The screen in FIG. 13 may be produced as follows. The holographic diffuser (a) is bonded onto the substrate having the focusing elements. One can bond a diffuser, or form it by replication as explained in reference to FIG. 9. The holographic surface is in the focal plane of the focusing elements, or in the region of this surface. The black film (c), as thin as possible, is applied onto the holographic surface. It is then engraved at the focal points by laser.

One then deposits, on the engraved black layer, a layer (b) with a higher refractive index, for example a polymer, as explained in reference to FIG. 12, or even a layer deposited by plasma as explained in reference to FIG. 7.

The advantage compared to the example in FIG. 12 is that the black layer (c) is a deeper black, due to the total absorption of the ambient light by the rough, blackened surface. The contrast is further improved. Said polymer layer also has the effect of protecting the black layer.

The production method avoids the problems of deposition of dust generated during the irradiation of the black layer to form the openings.

Finally, the thickness of the layer (b) is not critical. This layer can even serve as a link between the substrate and diffuser assembly and an external support (not shown), thus ensuring the rigidity of the screen. As previously, such a support may have a thickness of 4 mm or more with, if necessary, an anti-reflective layer.

FIG. 14 shows another embodiment of the diffuser in FIG. 13. It is similar to the one of FIG. 13, with a protecting coating on the active surface of the diffuser. Before depositing the black layer (c), the holographic surface is coated with a protective layer (d) by vacuum plasma deposition. One can use a dielectric layer of SiO₂ or nitride Si₃N₄ The thickness of the layer is preferably less than or equal to 1000 angstroms.

The function of this layer (d) is to protect, if necessary, the holographic surface against any attack from solvent contained in the suspension or in the solution used to form the black layer (c). This is particularly advantageous when the holographic surface is formed out of a plastic material. This layer (d) may also serve to promote the adhesion of the black layer. It also enables the holographic surface to be protected during any aggressive washing after the operation of engraving openings by laser in the black layer.

FIG. 15 shows another screen; the screen in FIG. 15 uses a diffuser that can be described as a “surface diffuser”, as defined above. This therefore leads to a high optical transmission while preventing practically any return of light towards the rear, apart from the reflection R=(n₁−n₂/n₁+n₂)², where n₁ is the index of the material of the diffuser and n₂ the index of the air on the side of the surface of the diffuser. For n₁ index values of around 1.4, the reflection is typically less than 3%.

As with the holographic diffuser mentioned in certain embodiments described above, the rough or active surface of said surface diffuser is contaminated by the contact of an adhesive. The assembly of the screen proposed in the example avoids the adhesive contaminating the diffuser.

Unlike the holographic diffuser, the surface diffuser emits practically the same light distribution lobe, whether it is illuminated on the active surface or the opposite surface. Thus, a diffuser with an active surface emitting in a lobe of ±23° when the light beam passes from the air into the diffuser emits in a lobe of ±18° when the light beam passes from the diffuser into the air. This makes it possible to use the surface diffuser by arranging it in the screen, in either one direction or the other; in the example shown in FIG. 15, the surface diffuser is arranged in such a way that it is illuminated on its smooth surface. One could also use the solution proposed in the example in FIG. 1 for the holographic diffuser.

FIG. 15 shows a cross-sectional view of a screen using a surface diffuser. One can see in the figure the support 12 with the focusing elements 14. The surface diffuser 24 is bonded with its smooth rear face against the substrate 12 by a film of transparent glue or adhesive 22 or directly replicated on the rear face of the substrate. The rough surface of the diffuser 24 stretches out substantially in the focal plane of the focusing elements 14 of the support.

On the active surface of the surface diffuser 24 is arranged an opaque layer 16, except in the vicinity of the focal points of the focusing elements 14. The openings 18 thus formed in the opaque layer have preferably a size less than 10%, or even 5%, of the total surface area of the screen, as indicated above.

The opaque layer 16 may be formed by the following two methods:
a) black ink screen printing or other printing technique (flexographic printing, lithographic printing, ink jet, etc.) followed by a laser engraving (YAG laser for example) with a laser beam focused by the microelements;
b) “lift-off”, with a negative photosensitive resin.

The laser technique allows very delicate engraving and a precise control of the size of the openings. One can particularly use a YAG laser beam at 1064 nm scanning the surface of the substrate 12 with focusing elements. It is also possible to use “stepper” exposure equipment of the type used in the semi-conductor industry. The exposure head is then equipped with a lamp that emits in a spectrum in the vicinity of 1064 nm (for example from 800 to 1200 nm). A laser of several tens of watts may be replaced by an exposure head of several hundreds of watts. One goes from a quasi-punctiform engraving to a surface engraving; values of 100×100 mm are possible, with a step by step displacement. The juxtaposition of the individual exposed zones may have a precision of several microns; one thus avoids any edge problems. As with the laser solution, this solution is based on a local destruction of the opaque layer through exposure.

The technique of forming openings in the opaque layer by the “lift-off” technique is as follows. A negative photosensitive layer—for example a commercially available resin that is sensitive to ultraviolet radiation—is formed on the rough surface of the diffuser, on the face directed away from the focusing elements. The layer has a higher thickness than that of the opaque layer to be obtained. Typically, the photosensitive layer has a thickness greater than or equal to double the black layer to be obtained; a thickness of several tens of microns is suitable.

The photosensitive layer is irradiated or exposed through the focusing elements by a suitable light; one can use a pre-focusing of the irradiation light in order to control the size of the openings. The exposure system is well known: for example, one uses a UV lamp at the source of a Fresnel lens at the output of which is placed the exposure frame, which is under vacuum, where the substrate to be exposed is positioned. One may also use machines based on UV diodes such as those used in the digital press market; these machines operate on the same principle as ink jet printers, with the laser diode(s) moving in relation to a drum or flat support.

The non-irradiated photosensitive layer is removed using known techniques in order to form islands of photosensitive resin, which are situated in the zones where the openings have to be located in the opaque layer.

One then applies the thin opaque layer—from 1 μm to several μm. The maximum thickness of the opaque layer is a function of the thickness of the photosensitive layer, which makes this technique more suitable to thin opaque layers. The opaque layer may be applied by spraying over the whole surface, for example using a spray gun. Other techniques, for example printing techniques, are possible, from the moment that they allow the thickness of the opaque layer to be controlled, in such a way that it remains substantially less than the thickness of the islands of photosensitive resin. One can, in particular, use professional ink jet printing equipment on large flat surfaces for said spraying.

One then removes the irradiated photosensitive layer with the help of a suitable solvent that is ineffective on the opaque layer. Thus, the resin islands crowned with a thin opaque layer are eliminated. The attack on said islands is a lateral attack on the sides of the exposed parts of the photosensitive layer where the black layer is absent or discontinuous given the steep incline of the lateral surface. This mode of attack explains why the photosensitive layer is deposited at a thickness greater than the thickness of the opaque layer, as explained hereabove.

Forming the black layer by the “lift-off” technique makes it possible to control the size of said openings. A disadvantage is the edge/centre non-uniformity that is possible from the exposure of the negative photosensitive layer; this disadvantage may be made up for by an efficient exposure of the photosensitive layer. Like the technique for forming openings by laser irradiation, forming the opaque layer by the “lift-off” technique is performed by applying an ink or suspension; this technique makes it possible to ensure that the opaque layer strongly adheres to the substrate. The “lift-off” technique has the advantage, compared to laser engraving, of less costly equipment.

The figure again shows a substrate 30, which is bonded onto the opaque layer using a film of glue or adhesive 28; the substrate may have an anti-reflective coating 32. In practice, it is advantageous to deposit, by any suitable means, the film 28 on the substrate 30, then to apply the whole assembly onto the opaque layer; good bonding may be obtained by lamination. This technique is economic and simple to use; the substrate 30 may have a thickness of 4 mm; the support 12 with focusing elements may have a low thickness, around one millimetre or less than one millimetre; the support coated with the opaque layer remains flexible and the lamination is perfectly suited to ensuring a solid fixation of the support on the substrate. One may for example use an adhesive film 28 of the type commercialised by the REXAM Company, with a thickness of 25 μm. One could also apply a layer of aqueous adhesive, which is then allowed to dry before the application and the lamination. Such a layer of aqueous adhesive layer may be applied by screen printing or sprayed, followed by drying.

The thicknessess of the opaque layer 16 and the adhesive film are such that the film of glue or adhesive applied beforehand on the screen support substrate 30 does not come into contact with the active surface of the diffuser 24. One thus ensures that the active surface of the diffuser is not contaminated through contact with the adhesive.

By way of example, if the roughness of the diffuser 24 is 10 microns (±5 μm in peak values) then the overthickness of the opaque layer 16 compared to the external peaks of the diffuser 24 may be from 5 to 10 μm, which leads to an opaque layer of around 10 to 15 μm thickness, measured in relation to the median plane of the rough surface of the example. In this case, an adhesive film 28 that is 25 μm thick, under the lamination pressure, penetrates by 10% of its thickness into the space 18; the film penetrates into the openings at a thickness of 3 μm. The opaque layer is not in contact with the adhesive, even for a minimum overthickness of 5 μm of the opaque layer 16 in relation to the peaks of the active surface of the diffuser.

It will be understood that the choice of thickness of the opaque layer depends on the thickness of the adhesive layer, as well as on the deformation of this layer of adhesive during the bonding. Whatever the case, it is possible to simply form the screen, while at the same time preserving the active surface of the diffuser. It is advantageous if the thickness of the opaque layer is less than 20 μm; nevertheless, it is also possible for this opaque layer to have a higher thickness.

FIG. 16 shows a larger scale view of the zone 10 of FIG. 15, in the vicinity of an opening 8. One recognises the diffuser 14, its active surface, the opaque layer 6 and the opening 8. The layer or film of adhesive 18 has penetrated into the opening, under the effect of the lamination pressure; as explained hereabove, it does not come into contact with the rough surface of the diffuser.

The invention is in nowise limited to the proposed examples. Thus, one can use the teaching of FIGS. 9 and 10 as to the production of the holographic diffuser for the other examples of screen. In the examples, the diffuser is fixed to the support, either directly, or indirectly with an intermediate layer of adhesive or other.

All embodiments of the display screen of the invention may be used with a Fresnel lens for collimating light received from the projector. In this case, light entering the display through the focusing elements is substantially collimated by the Fresnel lens.

One could also use a protective layer on the active surface of the diffuser, as explained in reference to the holographic diffuser.

The advantages of the different examples are to provide a very robust black layer, protected by other elements of the screen. The openings in the black layer may represent a low proportion of the total surface area of the screen, thus ensuring a high contrast.

In the case of a holographic diffuser, the roughness of the diffuser is around 5 μm at the maximum, i.e. more or less 2.5 μm. It is advantageous for the opaque layer to be as thin as possible, without however filling up the roughness; this explains the size of around one micrometer of the opaque layer for this kind of diffuser in the preceding example. A thickness of several micrometers may be adapted to other types of diffusers. Finally, the thinner the opaque layer, the easier it is to form openings in this layer: the low thickness of the layer reduces the engraving smoke.

1. A display screen comprising
a support (1) having focusing elements,
a diffuser (3) fixed to the support and having an active face directed away from the support and located substantially in the focal plane of the focusing elements;
an opaque layer (2) less than 20 micrometers thick having openings adapted to allow light focused by said focusing elements to pass therethrough.

2. The display screen according to claim 1, characterised in that the opaque layer to has a thickness less than 10 micrometers, preferably less than 5 micrometers, or even less than 2 micrometers.

3. The display screen according to claim 1, characterised in that the openings in the opaque layer have a surface area less than 10% or even 5% of the total surface area of the display screen.

4. The display screen according to claim 1, characterised in that the opaque layer is deposited on the active face of the diffuser.

5. The display screen according to claim 1, characterised in that it comprises, on the active face of the diffuser, a layer having a refractive index greater than the refractive index of the diffuser.

6. The display screen according to claim 5, characterised in that the layer having a higher refractive index comprises an organic-inorganic hybrid made by sol-gel process.

7. The display screen according to claim 5, characterised in that the layer having a higher refractive index comprises a polymer.

8. The display screen according to claim 5, characterised in that the opaque layer extends above the layer of higher refractive index.

9. The display screen according to claim 1, characterised in that it comprises, on the active face of the diffuser, a protective layer (d) and in that the opaque layer (c) extends above the protective layer.

10. The display screen according to claim 9, characterised in that it comprises, on the opaque layer, a layer having a refractive index higher than the refractive index of the diffuser.

11. The display screen according to claim 1, characterised in that the diffuser is a holographic diffuser.

12. The display screen according to claim 1, characterised in that the diffuser (24) is an active surface diffuser.

13. The display screen according to claim 12, characterised in that it has a substrate (30) bonded against the opaque layer (16) by an adhesive layer (28).

14. The display screen according to claim 13, characterised in that the thickness of the opaque layer (16) is higher than the thickness by which the adhesive layer extends out into an opening (18).

15. A method for producing a display screen comprising the steps of:—providing a support (1) with focusing elements,
providing a diffuser (3) having an active face;
applying the diffuser against the support with the active face thereof directed away from the support and substantially in the focal plane of the focusing elements;
forming an opaque layer (2) of a thickness less than 20 micrometers;
forming openings in the opaque layer by irradiation through the focusing elements and the diffuser.

16. The method according to claim 15, characterised in that the irradiation step comprises laser irradiation.

17. The method according to claim 15, characterised in that the step of forming an opaque layer (2) comprises the formation of an opaque layer on the active face of the diffuser.

18. The method according to claim 15, characterised in that it comprises a step of forming, on the active face of the diffuser, a layer having a higher refractive index than that of the diffuser, and in that the step of forming an opaque layer (2) comprises forming an opaque layer on the layer of higher refractive index.

19. The method according to claim 15, characterised in that it comprises forming, on the active face of the diffuser, a protective layer and in that the step of forming an opaque layer (2) comprises forming an opaque layer on the protective layer.

20. The method according to claim 19, characterised in that it further comprises a step of forming, on the opaque layer, a layer of higher refractive index than that of the diffuser.

21. The method of claim 15, characterised in that the step of providing a diffuser comprises providing a holographic diffuser.

22. The method according to claim 21, characterised in that the step of providing a holographic diffuser comprises:
forming a layer in a photohardening material;
applying a master holographic diffuser with the active face thereof against the layer in a photohardening material;
irradiating the photohardening material, and
removing the master holographic diffuser.

23. The method of claim 15, characterised in that the step of providing a diffuser comprises providing an active surface diffuser.

24. The method according to claim 23, characterised in that it comprises, in addition, a step of applying against the opaque layer a substrate (30) bonded beforehand.
